(19) United States
(12) Patent Application Publication
(10) Pub. No.: US 2026/0090594 A1
(43) Pub. Date: Apr. 2, 2026

(54) Belt with detachable multi-purpose cloth

(71) Applicants: Kristin Michelle Whissel, Orlando, FL (US); Joseph Thomas Whissel, Orlando, FL (US)

(72) Inventors: Kristin Michelle Whissel, Orlando, FL (US); Joseph Thomas Whissel, Orlando, FL (US)

(21) Appl. No.: 18/903,868

(22) Filed: Oct. 1, 2024

(51) Int. Cl. A41F 9/00; B08B 1/14

(52) U.S. Cl. CPC A41F 9/00; A45F 5/02; A45F 5/021; B08B 1/143

(57) ABSTRACT

A belt with a detachable multi-purpose cloth, comprising a strap configured to encircle the wearer's waist and a cloth with a fastening mechanism for attachment and detachment to the strap. The detachable cloth provides a convenient, quick, and always-accessible solution for cleaning various surfaces and handling sudden spills during daily activities. The cloth can be reattached to the belt if it remains clean after use. The cloth may also remain attached to the belt and be used to wipe hands, other body parts, or clothes if they become soiled. The cloth is made from a soft, comfortable, absorbent fabric such as terry cloth, muslin, flannel, knit, or similar materials. The belt includes an embellishment that makes it attractive for the wearer to wear at all times, whether in private or public, ensuring it is always available.

### TECHNICAL FIELD

This invention relates to the field of cleaning and hygiene. More specifically, it pertains to a belt with a detachable multi-purpose cloth used for various cleaning and hygienic tasks and handling sudden spills.

### BACKGROUND

Maintaining cleanliness in various environments often exposes individuals to spills and messes at both predictable and unpredictable moments, leading to soiling of clothes and surfaces. Traditional multi-purpose cloths are typically stored in a designated area, which may not be immediately accessible during sudden spills or messes. These solutions do not offer a convenient, quick, and always-accessible option. Existing cloths are often designed for specific uses and may not be versatile enough to handle different types of messes quickly and effectively.

The present invention addresses the shortcomings of prior art by providing a belt with a detachable multi-purpose cloth that offers a convenient, always-accessible solution for both predictable and unpredictable spills and messes. The belt with detachable cloth is designed to be attractive, encouraging individuals to wear it at all times. The belt may feature an ornamental embellishment, such as a bow or similar design. The cloth is made from absorbent materials and can be easily attached and detached using various fastening mechanisms. The belt can accommodate different waist sizes, and the cloth can be detached using mechanisms such as buttonholes with opposing hooks, magnets, or other fastening mechanisms.

### SUMMARY

The present invention addresses the shortcomings of prior art by providing a belt with a detachable multi-purpose cloth that offers a convenient, always-accessible solution for both predictable and unpredictable spills and messes. The belt with detachable cloth is designed to be attractive, encouraging individuals to wear it at all times. The belt may feature an ornamental embellishment, such as a bow or similar design. The cloth is made from absorbent materials and can be easily attached and detached using various fastening mechanisms. The belt can accommodate different waist sizes, and the cloth can be detached using mechanisms such as buttonholes with opposing hooks, magnets, or other fastening mechanisms. This versatile cloth can be used for wiping spills, catching infant spit-up, cleaning surfaces, drying hands, or any other cleaning or hygienic needs, making it a practical and stylish accessory for everyday use.

### BRIEF DESCRIPTION OF DRAWINGS

FIG. 1 is a front elevational view of one embodiment of a belt with detachable cloth

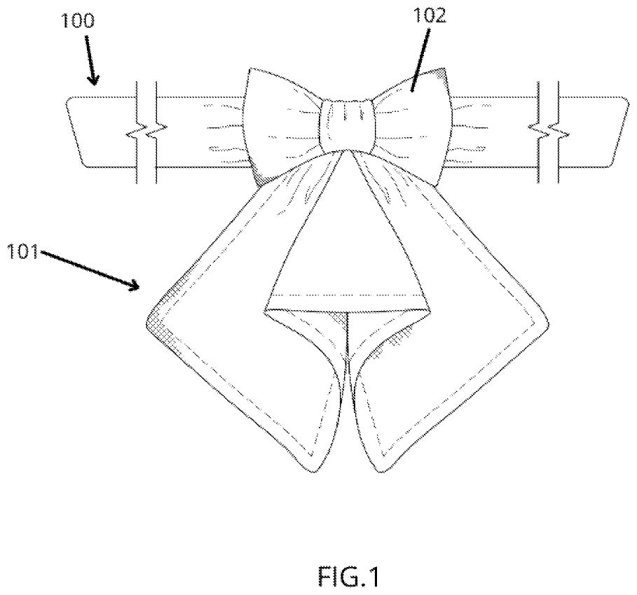

FIG. 2 is a rear elevation view of the embodiment of FIG. 1

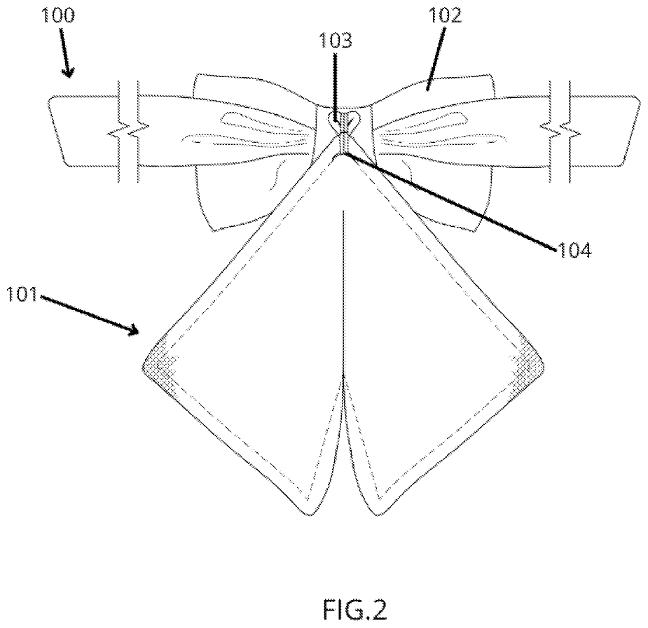

FIG. 3 is a rear view of the embodiment of FIG. 1 shown with the cloth detached from the belt,

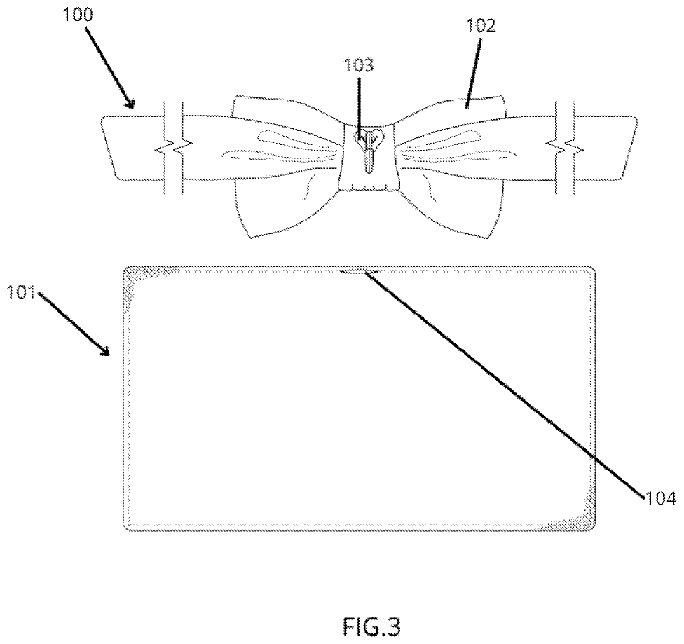

FIG. 4 is a front view of the embodiment of FIG. 1 shown with the cloth detached from the belt,

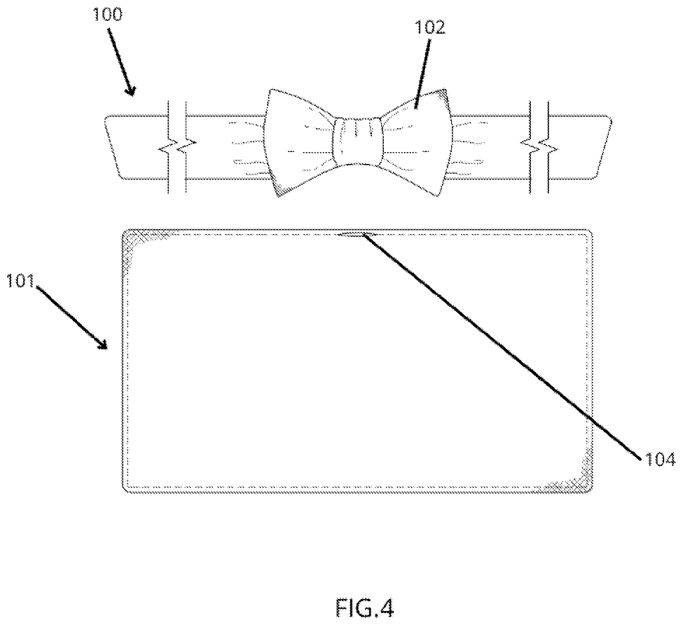

FIG. 5 is a front elevational view of the embodiment of FIG. 1, shown in use, worn on the wearer's waist with cloth detached and worn over wearer's shoulder;

FIG. 6 is a rear elevational view of the embodiment of FIG. 1, shown in use, worn on the wearer's waist with cloth detached and worn over wearer's shoulder;

FIG. 7 is a front elevational view of the embodiment of FIG. 1, shown in use, worn on the wearer's waist with cloth attached to belt,

FIG. 8 is a right side elevational view of the embodiment of FIG. 1, shown in use, worn on the wearer's waist with cloth detached from belt and worn over shoulder

### DETAILED DESCRIPTION OF THE EMBODIMENTS

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments are described herein with reference to schematic illustrations of embodiments of the disclosure. As such, the actual dimensions of the layers and elements can be different, and variations from the shapes of the illustrations as a result, for example, of manufacturing techniques and/or tolerances, are expected. For example, a region illustrated or described as square or rectangular can have rounded or curved features, and regions shown as straight lines may have some irregularity. Thus, the regions illustrated in the figures are schematic and their shapes are not intended to illustrate the precise shape of a region of a device and are not intended to limit the scope of the disclosure. Additionally, sizes of structures or regions may be exaggerated relative to other structures or regions for illustrative purposes and, thus, are provided to illustrate the general structures of the present subject matter and may or may not be drawn to scale. Common elements between figures may be shown herein with common element numbers and may not be subsequently re-described.

The present disclosure relates to a belt with a detachable multi-purpose cloth. Belts are often ornamental. In some instances, belts also have a functional aspect. As described below, belts can be made functional by carrying a multi-purpose cloth that is immediately accessible during sudden spills or messes.

Reference will now be made in detail to embodiments of the present invention, examples of which are illustrated in the accompanying drawings. Embodiments, or examples of a belt with detachable cloth may be implemented in numerous ways. A detailed description of one or more examples is provided below along with accompanying figures. The detailed description is provided in connection with such examples, but is not limited to any particular example. Details are set forth in the following description in order to provide a thorough understanding. These details are provided for the purpose of example and the descriptions provided may be used for implementation without some or all of these specific details. For the purpose of clarity, technical material that is known in the technical fields related to the examples has not been described in detail to avoid unnecessarily obscuring the description.

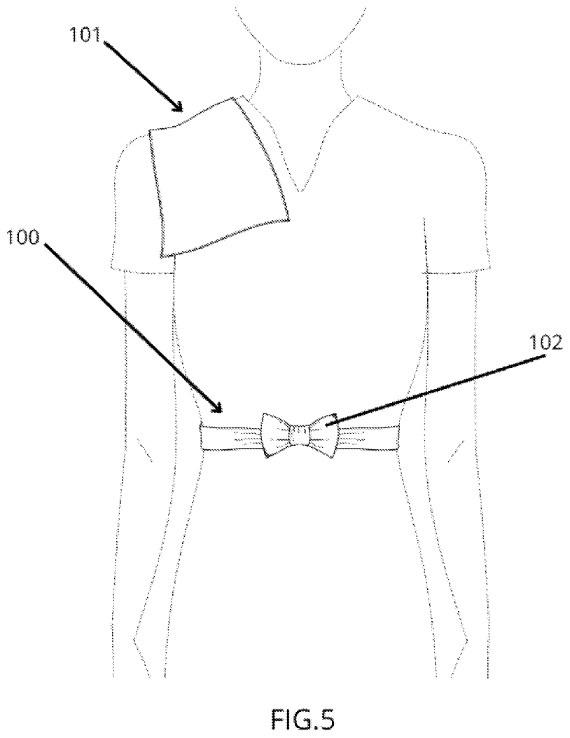

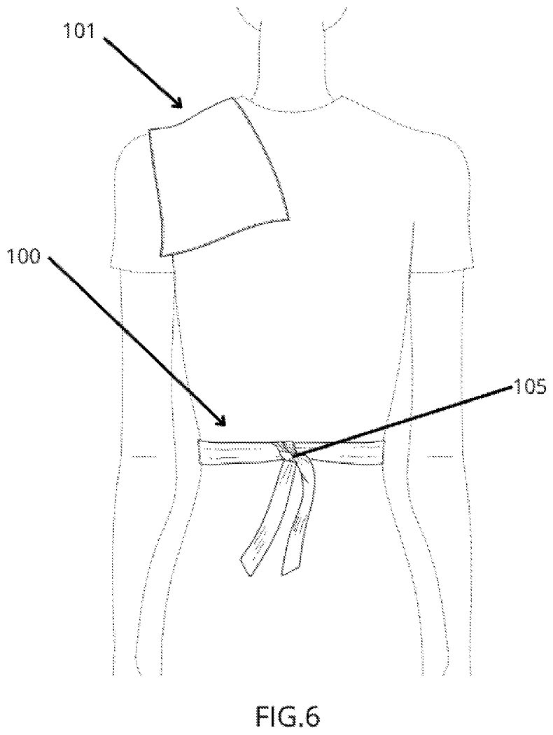

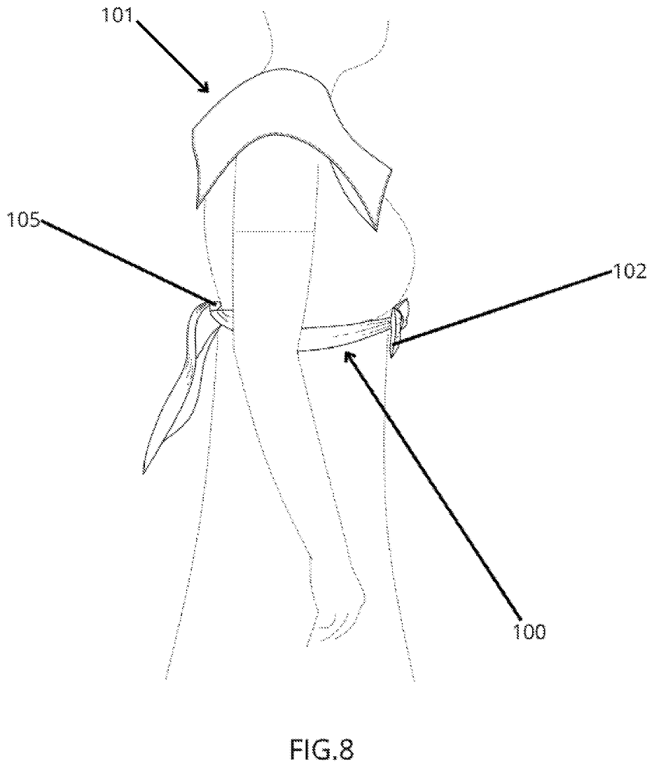

One embodiment of a belt with detachable cloth allows the wearer to detach a hanging cloth 101 from a belt 100, thereby providing a multi-purpose cloth that can be used for various purposes, such as wiping spills, cleaning surfaces, catching infant spit-up, drying hands, or any other cleaning or hygienic needs, as depicted in FIG. 5, FIG. 6, FIG. 8. Additionally, a belt with detachable cloth may allow the wearer to wipe their hands, soiled body part, or clothing during a fluid exposure such as spills, drool, or other messes while the cloth is attached to the belt. The cloth may be reattached in the event that the wearer or another person were not soiled.

One embodiment of a belt with detachable cloth allows the wearer to use a fastener to allow them to detach and reattach the protective cloth from the belt. Although this embodiment is not limited to how the cloth is fastened to the belt, the cloth may be detached from the belt via a buttonhole 104 on the cloth and a sew-in hook 103 on the belt 100. The cloth may be detached from the belt via a magnet in the cloth and magnet in the belt. A belt with detachable cloth is not limited by a certain fastener and/or the material(s) used to attach cloth to the belt.

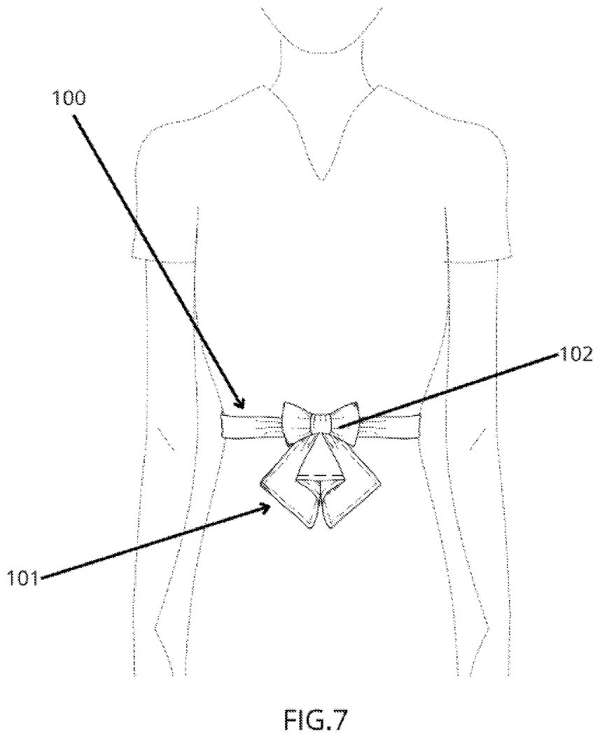

The belt 100 with detachable cloth 101 may have an embellishment in the shape of a bow 102 or other similar shaped body that when worn around the waist of the wearer, a detachable cloth may hang from, as depicted in FIG. 7. Although this embodiment is not limited to the type of material which may be used, in one aspect the embellishment may be constructed from a soft, comfortable, such as, flannel, knit, or other like material; and/or a water impervious material like nylon or other like material. An embellishment may have a middle panel that may include a filler like padding such as a soft batting or foam.

Although this embodiment is not limited to the type of material which may be used, in one aspect the detachable cloth may be constructed from a soft, comfortable, absorbent fabric, such as terry cloth, muslin, flannel, knit, or other like material; and/or a water impervious material like nylon or other like material. The detachable cloth has the option to be reversible and either the top surface or bottom surface may be worn outwardly on the wearer. Each of the reversible surfaces may be of the same material, or of different materials with the same or different properties. One embodiment of a cloth may have one side made from a very absorbent material for larger spills, whereas the other may be a lighter material for quick wipes.

Although this embodiment is not limited to the type of material which may be used, in one aspect the belt may be constructed from a soft, comfortable, such as, flannel, knit, or other like material; and/or a water impervious material like nylon or other like material

Although this embodiment is not limited to how the belt is fitted to the wearer, a belt 100 with detachable cloth 101 may allow wearers of various waist sizes to wear the belt around their waist. The belt may be fitted by making a knot 105 at the back of the wearer or stretching as a band around the wearer's waist.

One embodiment of a belt with detachable cloth allows the wearer to have interchangeable cloths 101 with different colors, patterns, or textures for various aesthetic or functional purposes.

Various alternative implementations and modifications to the examples provided may be used and are not limited to the descriptions, dimensions, and/or other details provided herein.

1. A belt comprising:
a strap configured to encircle a user's waist;
a detachable cloth removably attached to the strap, wherein the cloth includes fastening mechanisms for attachment and detachment from the strap.

2. The belt of claim 1, wherein the fastening mechanism comprises:
a buckle, magnet, clip, snap, or hook-and-loop fastener, button and buttonhole, hook-and-eye fastener, hook and buttonhole, toggle fastener.

3. The belt of claim 1, wherein the cloth is made from an absorbent fabric selected from the group consisting of terry cloth, muslin, flannel, or knit.

4. The belt of claim 1, further comprising an ornamental embellishment on the strap to encourage continuous wear by the user.

5. The belt of claim 1, wherein the strap can be adjusted to fit various waist sizes.
